(19) United States
(12) Patent Application Publication
(10) Pub. No.: US 2011/0177324 A1
(43) Pub. Date: Jul. 21, 2011

(54) TEMPORARY PROTECTION OF GLASS

(75) Inventors: Georges Zagdoun, La Garenne Colombes (FR); Eddy Royer, Villemomble (FR)

(73) Assignee: SAINT-GOBAIN GLASS FRANCE, Courbevoie (FR)

(21) Appl. No.: 12/993,978

(22) PCT Filed: May 25, 2009
(86) PCT No.: PCT/FR2009/050962

§ 371 Date: Feb. 14, 2011

(30) Foreign Application Priority Data
May 26, 2008 (FR) 0853406

(51) Int. Cl. B32B 5/16; B32B 17/06; B32B 17/10; B32B 3/00; B05D 3/02; B05D 3/00

(52) U.S. Cl. 428/327; 428/426; 428/441; 428/336; 427/385.5; 427/154

(57) ABSTRACT

One subject of the invention is a glass substrate coated with a continuous temporary protection film, said film essentially consisting of a stack of discernible colloidal polymer particles. Another subject of the invention is a process for coating a glass substrate with a continuous temporary protection film, in which process an aqueous dispersion of colloidal particles of at least one water-insoluble solid polymer is deposited on at least one surface of said substrate and then the film thus obtained is dried at a temperature above the glass transition temperature of said at least one polymer but not exceeding 50° C.

The invention relates to the field of glass protection films.

During the steps of glass manufacture, conversion, transport or storage, the surface of the glass is liable to be contaminated with various chemical agents or mechanically damaged. To give an example, the conversion of glazing, for the purpose of producing insulating multiple (double or triple) glazing, sometimes involves silicone-based seals or mastics. For a certain period, limited in time, after application, said seals have a tendency to emit silicone vapors (monomers or oligomers that have not completely polymerized), which migrate to the surface of the glass and contaminate it. The silicone film is extremely adherent to the glass owing to their chemical similarity, thereby considerably complicating steps for cleaning the glazing. It is therefore recommended to limit silicone contamination as far as possible.

This problem is particularly significant when it is desired to exploit the surface properties, especially the hydrophilic properties, of films deposited on the glass. For example, it is known to deposit films based on photocatalytic titanium oxide on the glass. For example, patent application EP-A-0 850 204 describes titanium-oxide-based films which, owing to their photocatalytic and photo-induced super-hydrophilic properties, make the surface of the glass self-cleaning and antisoiling. Silcone contamination is then likely to reduce the properties of the films to nothing.

It is therefore important to have systems for temporarily protecting the surface of the glass from this type of contamination.

It is known to protect the surface of glass with peelable adhesive polymer films. These films may be deposited in the solid state (such as for example in patent application EP-A-1 610 940), or in the liquid state. In the latter case, illustrated for example by the patent U.S. Pat. No. 5,866,199, a polymer solution is deposited on the glass, giving after polymerization a continuous film adherent to the glass and able to be removed by peeling it off. However, to deposit an adhesive film in the solid state requires a rather complex deposition installation. Furthermore, the peeling step is often quite lengthy and tricky and may leave traces of adhesive on the surface of the glass.

Polymer films obtained from a liquid phase and able to be removed by cleaning using aqueous solutions have been developed. US patent application 2002/0176988 describes for example the deposition of aqueous solutions or dispersions of various polymers, which form protection films that can be removed, in certain cases, by washing with water or using basic aqueous solutions. In general, the films obtained from aqueous solutions of polymers (for example polyvinyl alcohol, as described in the aforementioned US patent application 2002/0176988, or acrylic polymers, as in patent application WO 00/50354) can be easily removed using water, since the polymer is itself soluble in water. However, such films are not very resistant and have a tendency to be removed very rapidly, for example through the action of rainwater. The protection is consequently too short and, to repeat the example of self-cleaning multiple glazing, the protection film is removed before the silicone seals have finished emitting silicone vapors. The prior art also describes films obtained from aqueous dispersions, and therefore water-insoluble polymers, which are more durable but require the use of basic solutions (for example those based on ammonium hydroxide, as described in patent application US 2002/0176988) or special detergents and organic substances that detach the film from the surface of the glass before cleaning with water (as described in the patent U.S. Pat. No. 5 453 459). These solutions or detergents are tricky to handle and/or are relatively environmentally unfriendly. There therefore remains a need to have temporary protection films that are both sufficiently durable and able to be removed with water. The protection film must for example be able to be easily removed by the occupants of the dwelling or by a glazier after a few weeks or months of exposure, and therefore after the silicone seals have finished emitting silicone vapors.

The purpose of the invention is therefore to provide a temporary protection film for glass, which has sufficient durability but can be removed using pure water.

For this purpose, one subject of the invention is a glass substrate coated with a continuous temporary protection film, said film essentially consisting of a stack of discernible colloidal polymer particles. Preferably, the polymer particles consist of particles of a water-insoluble solid polymer.

Another subject of the invention is a process for obtaining said substrate. This is in particular a process for coating a glass substrate with a continuous temporary protection film, in which process an aqueous dispersion of colloidal particles of at least one water-insoluble solid polymer is deposited on at least one surface of said substrate and then the film thus obtained is dried at a temperature above the glass transition temperature of said at least one polymer but not exceeding 50° C.

In the rest of the description, the term “colloidal aqueous dispersion” is understood to mean the dispersion of colloidal particles in water.

In the rest of the text, the preferred embodiments apply in the same way to both subjects of the invention, namely the coated substrate and the process for obtaining it.

The invention therefore consists in depositing a weakly adherent film on the glass substrate, said film simply consisting of a stack of small hard polymer spheres. Since these hard spheres do not establish strong chemical bonds, either between themselves or with the surface of the glass, the film obtained can be easily removed using pure water, whether cold or warm, without having to require highly basic solutions or potentially polluting organic compounds. All the same, the cohesion of the film is provided by weak forces, of the van der Waals force or electrostatic force type, and its abrasion/rub resistance is remarkable. Preferably, the film according to the invention is abrasion-resistant in the sense that it is resistant to at least 500 cycles, or even at least 2000 cycles, in the test described in the EN 1096-2 standard, this test being explained later in the text.

However, the protective films of the prior art obtained from aqueous dispersions of water-insoluble polymers exhibit rather strong cohesion, due probably to chemical polymerization reactions or partial melting and bonding of the particles, thereby requiring the use of basic solutions or special organic substances.

The term “essentially consists of” is understood to mean that the protection film may optionally include other compounds, in trace amounts, which have no influence on the way in which the film solves the technical problem at the basis of the invention. Preferably, the film according to the invention consists of a stack of discernible colloidal polymer particles.

The aqueous colloidal dispersion preferably consists of water and colloidal polymer particles, and therefore excluding any other chemical agent (such as for example pigments, binders, plasticizers, etc.). Likewise, the aqueous colloidal dispersion is preferably the sole compound used to form the temporary protection film.

The drying is carried out at a temperature above the glass transition temperature of the polymer so as to obtain a continuous film. This is because it has been observed that, below this glass transition temperature, the drying is accompanied by the creation of cracks, destroying the continuous character of the protection film. The drying is however carried out at a temperature of at most 50° C. so as to preserve the well-discernible particles, which do not coalesce during drying. Too high a temperature runs the risk of creating a film consisting no longer of small discernible hard spheres but of particles bonded together, to the detriment of the ease of subsequent removal. Preferably, the drying is carried out at a temperature close to room temperature or at a temperature slightly higher, for example between 25 and 35° C. Preferably, no heating means (such as, for example, infrared lamps) and/or no forced drying means, such as ventilation systems or hot air or cold air blowing systems, are/is employed, possibly with the exception of mild drying means (at temperatures slightly above room temperature), which may employ hot-air drying or drying with a few infrared lamps. Excessively long or excessively strong heating or drying runs the risk of forming films in which the polymer particles are no longer discernible, but instead bonded together, which have partly or completely melted, the films obtained then being difficult to remove. Forced drying or heating means are unnecessary most of the time, since it has been observed that film drying can take place very naturally in a few minutes, typically less than three minutes or even less than two minutes.

Generally speaking, it is preferable for the shape and the size of the colloidal particles not to be substantially modified by the drying. This feature is in general proof of the absence of strong bonds between the particles, this being a key factor for obtaining the desired effect of removal using water. In general, it is obtained by rapid drying at a temperature which is not too high relative to the glass transition temperature of the polymer.

The average diameter of the colloidal polymer particles in the aqueous colloidal dispersion and/or in the temporary film is preferably between 40 and 500 nm, especially between 50 and 300 nm and even between 80 and 250 nm.

Preferably, the polymer is an acrylic polymer or copolymer, for example a styrene-acrylic copolymer. This type of polymer has the advantage of adhering very weakly to the surface of the glass, thereby enabling the film to be easily removed. Furthermore, acrylic dispersions are easily obtained by emulsion polymerization reactions, which give particles of controlled and reproducible size. Other types of polymer can be used, for example polyurethanes. These polymers do not have particular chemical affinity with silicones, and it has been observed that silicones do not migrate and graft onto this type of polymer, which is an additional advantage of the protection film according to the invention.

Preferably, the polymer employed in the dispersion is completely polymerized so as to avoid any polymerization reaction between the various particles during drying and/or subsequently, since such chemical reactions would increase the cohesion of the film undesirably and prevent removal using pure water.

Preferably, the glass transition temperature of the or each polymer is less than or equal to 30° C. and/or greater than or equal to 20° C. The reason for this is that it has been observed that the glass transition temperature has an influence on the water resistance of the films obtained. When the glass transition temperature of the polymer is below about 20° C., the film is more easily removable using cold water. For higher glass transition temperatures (which therefore require drying at a higher temperature), the film obtained is more resistant to cold water (and will therefore be more rain-resistant), but it can be removed using warm water.

The aqueous colloidal dispersion may be deposited by various techniques, such as flow coating, dip coating, curtain coating or spray coating.

To provide optimum protection, the thickness of the temporary protection film (where appropriate after drying) is preferably between 2 and 100 microns, especially between 5 and 50 microns or even between 10 and 30 microns.

The glass substrate is generally a glass pane such as a flat or curved window, simple or multiple (double, triple, etc.) glazing, toughened or annealed glazing, clear or tinted glazing, etc., the thickness of which is especially between 1 and 19 mm, more particularly between 2 and 10 mm and even between 3 and 6 mm. This substrate or glazing may itself be covered on at least one of its sides with thin films or multilayer coatings giving optical properties (mirror or antireflection films, etc.), thermal properties (low-E (low-emissivity) or solar-protection films, especially those based on silver films) or electrical properties (antistatic films, transparent conductive films). In this case, the temporary protection film also protects films deposited on the substrate.

The protection film may coat one of the surfaces or both surfaces of the glazing.

The substrate to be coated preferably comprises, beneath the temporary protection film, at least one hydrophilic film, especially a film based on photocatalytic titanium oxide. Preferably, the hydrophilic film is in contact with the temporary protection film, since hydrophilic films are more liable to have their functionalities affected by external contamination such as by silicones. Preferably, the titanium-oxide-based film is the last film deposited on the substrate before deposition of the temporary protection film according to the invention. The titanium-oxide-based film may consist of titanium oxide, deposited especially by a sol-gel process, by a CVD (chemical vapor deposition) process or by a cathode sputtering process (for example by magnetron sputtering). Alternatively, the titanium-oxide-based film may be composed of titanium oxide particles incorporated into a mineral binder, for example a silica binder obtained by a sol-gel process. The hydrophilic film, and especially if this is a film based on photocatalytic titanium oxide, is preferably deposited on an underlayer acting as barrier to the migration of alkali metal ions, especially an underlayer made of a silicon derivative, such as silicon oxide, nitride or oxycarbide, or any mixture thereof. Alternatively or additionally, the hydrophilic film, especially one based on photocatalytic titanium oxide, may be combined with other types of underlayers, especially with films having an optical function (antireflection films or films that attenuate reflection from the titanium oxide) or having a thermal function (solar-protection films or low-E films, especially of the type comprising at least one thin silver film or a transparent conductive film).

The protection film according to the invention is resistant to rubbing and to abrasion. It can therefore be deposited during manufacture of the glazing, and is resistant to storage, conversion, transport and on-site installation. The protection film according to the invention may for example be deposited just after the thin films have been deposited on the glass. In the case of insulating glazing (multiple glazing, especially double glazing or triple glazing), the protection film according to the invention may be deposited at various stages during conversion. A multiple glazing unit is obtained by assembling several glass sheets, generally two or even three, around a generally metallic peripheral frame, using a butyl seal. This seal itself is protected by a peripheral mastic coated over the entire edge of the insulating glazing. In the case of what are called structural insulating glazing units, in the sense that these are not inserted into the windowframe rebate, the peripheral mastic is generally a silicone mastic. In this case, it is preferable for the protective film according to the invention to be deposited either before this coating step, so as to protect the hydrophilic function from silicone vapors, or just before assembly of the sheets and frame, or just after this assembly. In the case of glazing intended to be inserted into the frames, for example those based on PVC, aluminum or wood, the peripheral mastic is not generally based on a silicone. In this case, it is preferable and simpler to deposit the protective film after coating with the mastic, and therefore as the last step in the process for manufacturing the insulating glazing. Alternatively, it may be deposited before assembly or before coating. Thus, the insulating glazing remains protected throughout all the following steps, namely storage, transport to the work site and installation on site, during which steps the glazing may be exposed to accidental contamination, especially silicone contaminations.

The protection film may be deposited on the surface of a glass pane coated with a film of photocatalytic titanium oxide, said pane being intended to equip a double or triple glazing unit and the photocatalytic film being located toward the outside of the building. The temporary protection film may be removed after installation on site, or retained for a few weeks, i.e. the time for the silicone seals of the multiple glazing to have finished emitting silicone vapors. Once this period has elapsed, the temporary protection film that has protected the glazing from silicone vapors can be easily removed using cold or warm water.

Yet another subject of the invention is a method of using the temporary protection film according to the invention, in which said protection film is used for temporarily protecting glazing surfaces, and then said temporary protection film is removed using cold or warm water. The water is preferably pure, in the sense that it does not contain organic compounds (for example detergents) or inorganic compounds (for example ammonium salts) with the exception of traces that cannot easily be avoided. The pH of the water employed is preferably between 6 and 8, especially between 6.5 and 7.5. The pH may sometimes be less than 6, especially in the case of deionized water.

It goes without saying that the various combinations of preferred features of the invention themselves constitute preferred embodiments of the invention.

The invention will be better understood in the light of the figure and the following nonlimiting examples.

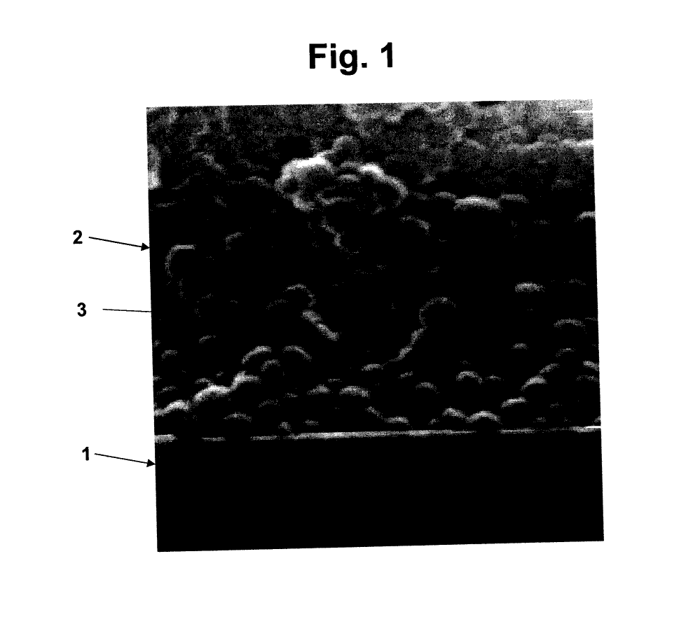

FIG. 1 shows a scanning electron micrograph of a section through a glass specimen covered with a protection film according to the invention. FIG. 1 shows part of the glass substrate 1 covered with a protection film 2 according to the invention, only part of said film being visible in the figure. The protection film 2 consists of an assembly of numerous perfectly discernible colloidal particles 3.

### EXAMPLE 1

The glass substrate to be coated was a flat glass substrate about 6 mm in thickness obtained by a float process (said float process consisting in pouring molten glass onto a bath of molten tin). This substrate was coated beforehand with a silicon oxycarbide (SiOC) film, itself surmounted by a 15 nm thick film of photocatalytic titanium oxide. These two films were obtained by a CVD process, in which organometallic or halide precursors were brought in vapor phase close to the hot glass ribbon after forming by the float process.

The colloidal dispersion employed was an aqueous dispersion of an acrylic copolymer sold under the name NeoCryl XK-240 by DSM NeoResins. This dispersion was made up of 48 wt % water and 52 wt % particles of an acrylic copolymer, the average diameter of which was about 180 nm (measured by known methods, employing light scattering). The glass transition temperature of the polymer was −4° C. The viscosity of the dispersion at 25° C. was 160 mPa.s and its pH 7.5.

The dispersion was deposited on the glass substrate by dip coating and, after drying at room temperature without forced ventilation for a few minutes (typically 2 to 3 minutes), the film obtained was continuous, with a thickness of about 20 microns. The light transmission of the protection film was around 88% and the haze was around 30%.

The film was abrasion-resistant within the meaning of the EN 1096-2 standard. The test consisted in applying, to a 9.4 cm long part of the coated surface—this part being called a track—a felt of 14 mm diameter, 10 mm thickness and 0.52 g/cm² density, under a load of 39.22 MPa (400 g/cm²) , the felt being subjected to a translational movement (50 to-and-fro movements over the entire track length per minute) combined with a rotation at 6 rpm (1 cycle=1 to-and-fro movement). The film according to the invention withstood at least 2000 cycles.

The temporary protection film may nevertheless be very easily removed by spraying it with pure water (the addition of no organic additives) at room temperature.

Tests for characterizing the contamination with silicones were also carried out. These tests consisted in placing the coated substrate of Example 1 in contact with a bead of silicone (Dow Corning reference 787s) and in measuring the contact angle with water after 7 days. A comparative example was also tested in parallel, consisting of a substrate not coated with the protection film according to the invention. After 7 days, the contact angle with water for the comparative example changed from 30° to more than 75°, testifying to quite strong contamination with silicone vapors. In contrast, the contact angle with water for the specimen of Example 1 remained stable, below 35°. This result clearly shows that the silicone vapors do not graft onto the protection film according to the invention.

### EXAMPLE 2

The substrate to be coated was identical to that employed in the case of Example 1.

The colloidal dispersion employed was an aqueous dispersion of an acrylic copolymer sold under the name NeoCryl XK-87 by DSM NeoResins. This dispersion consisted of 49 wt % water and 51 wt % particles of a styrene-acrylic copolymer, the average diameter of which was about 210 nm. The glass transition temperature of the polymer was 24° C. The viscosity of the dispersion at 25° C. was 250 mPa.s and its pH 7.4.

This dispersion was applied as in the case of Example 1, but the drying here was carried out at 35° C. so as to maintain a temperature above the glass transition temperature of the polymer. Deposition at a lower temperature (for example 20° C.) resulted in a discontinuous film.

The optical properties and the rub resistance properties were similar to those of Example 1. However, the film was resistant to cold water, and therefore able to withstand foul weather. However, the film could be easily removed using warm water (at about 30 to 35° C.), while applying slight rubbing using a sponge or rag.

### COMPARATIVE EXAMPLE

The substrate to be coated was identical to that employed in the case of Example 1.

The colloidal dispersion employed was an aqueous dispersion of an acrylic copolymer sold under the name NeoCryl XK-52 by DSM NeoResins.

This dispersion consisted of 60 wt % water and 40 wt % particles of an acrylic copolymer, the average diameter of which was about 70 nm. The glass transition temperature of the polymer was 115° C. The viscosity of the dispersion at 25° C. was 15 mPa.s and its pH 5.1.

This dispersion was applied as in the case of Example 1, and the drying here was carried out at 35° C. as in Example 2. The deposition, carried out at a temperature below the glass transition temperature of the polymer, resulted in a discontinuous film, consisting of domains having a size of around ten microns, separated by cracks. Such a discontinuous film cannot effectively protect the surface of the substrate, in particular against contamination resulting from the migration of silicone vapors.

1. A glass substrate, comprising a coating, said coating being a continuous temporary protection film, said film essentially consisting of a stack of discernible colloidal polymer particles comprising a same or different polymer.

2. The substrate of claim 1, wherein an average diameter of the colloidal polymer particles is between 40 and 500 nm.

3. The substrate of claim 1, wherein the polymer is an acrylic polymer or an acrylic copolymer.

4. The substrate of claim 1, wherein a glass transition temperature of each polymer is less than or equal to 30° C. and/or greater than or equal to 20° C.

5. The substrate of claim 1, wherein a thickness of the temporary protection film is between 2 and 100 microns.

6. The substrate of claim 1, comprising, beneath the temporary protection film, at least one hydrophilic film.

7. A process for coating a glass substrate with a continuous temporary protection film, the process comprising:
depositing an aqueous dispersion of colloidal polymer particles of at least one water-insoluble solid polymer on at least one surface of said substrate, to give a film; and then
drying the film thus obtained at a temperature above a glass transition temperature of said at least one polymer but not exceeding 50° C.

8. The process of claim 7, wherein the aqueous dispersion consists of water and said colloidal polymer particles.

9. The process of claim 7, wherein shape and size of the colloidal particles are not substantially modified by the drying.

10. The process of claim 7, wherein the depositing of the aqueous dispersion of colloidal polymer particles is carried out by flow coating, dip coating, curtain coating, or spray coating.

11. A method of temporarily protecting a glazing surface, the method comprising contacting the temporary protection film of claim 1 with the glazing surface and then removing said temporary protection film with cold or warm water.

12. The substrate of claim 1, wherein an average diameter of the colloidal polymer particles is between 50 and 300 nm.

13. The substrate of claim 2, wherein the polymer is an acrylic polymer or copolymer.

14. The substrate of claim 12, wherein the polymer is an acrylic polymer or copolymer.

15. The substrate of claim 2, wherein a glass transition temperature of each polymer is less than or equal to 30° C. and/or greater than or equal to 20° C.

16. The substrate of claim 12 wherein a glass transition temperature of each polymer is less than or equal to 30° C. and/or greater than or equal to 20° C.

17. The substrate of claim 3, wherein a glass transition temperature of each polymer is less than or equal to 30° C. and/or greater than or equal to 20° C.

18. The substrate of claim 13, wherein a glass transition temperature of each polymer is less than or equal to 30° C. and/or greater than or equal to 20° C.

19. The substrate of claim 14, wherein a glass transition temperature of each polymer is less than or equal to 30° C. and/or greater than or equal to 20° C.

20. The substrate of claim 1, wherein a thickness of the temporary protection film is between 5 and 50 microns.
